(19) United States
(12) Patent Application Publication
(10) Pub. No.: US 2005/0189206 A1
(43) Pub. Date: Sep. 1, 2005

(54) Direct current cutoff switch

(76) Inventor: Hideaki Takeda, Saitama (JP)

Correspondence Address: GREER, BURNS & CRAIN, 300 S WACKER DR, 25TH FLOOR, CHICAGO, IL, 60606, US

(21) Appl. No.: 10/517,179

(22) PCT Filed: May 22, 2003
(86) PCT No.: PCT/JP03/06413

§ 371 Date: Dec. 7, 2004

(30) Foreign Application Priority Data
Jun. 11, 2002 (JP) 2002-169762

(51) Int. Cl. H01H 5/00

(52) U.S. Cl. 200/400

(57) ABSTRACT

In a manually operated switch for cutting off direct current, a PTC 9 as a non-linear resistor is parallel connected to a contact circuit composed of a first fixed contact 5-1 and a first movable contact 4-1, via a connecting unit 3-1, a top electrode 9-1, a bottom electrode 9-2, a connecting wire 6a and a movable unit 6. Firstly, the first fixed contact 5-1 and the first movable contact 4-1 are opened. However, since the PTC 9 is parallel connected and the contact circuit forms a closed circuit, surge voltage is difficult to occur, and cutoff current flows in the PTC 9. After peak current passes by the decrease of a resistance value due to the instantaneous heating of the PTC 9, voltage returns to power supply voltage by the increase of the resistance value of the PTC 9, and then the fixed contact 5-2 and the second movable contact 4-2 are opened. Accordingly, current is completely cut off.

### TECHNICAL FIELD

The present invention relates to a direct current cutoff switch, more particularly, to a direct current cutoff switch for preventing contacts from melting down and reducing its damage by getting rid of or reducing the occurrence time of the contact-opening arc of a high-voltage current circuit, and completely cutting off high-voltage direct current.

### BACKGROUND ART

There is conventionally a switch used for the opening/closing of a direct current circuit in the electrical equipment of automobiles, electronic products driven by a charging battery or the like. Power supply voltage for driving the electrical equipment of the conventional automobile in which such a switch is used is mainly DC 12V or DC 24V, and power supply voltage for portable electronic equipment using a charging battery is also mainly DC12V.

Even motor-driven tools required to output high power can be sufficiently driven by DC 18V or 24V, and the conventional switch has been used as a switch for such a power supply unit without any modifications without any troubles.

However, recently, high power has been demanded for the power supply unit of such a motor-driven device by high-voltage electrical equipment for automobiles, the expansion in product field of devices using a charging battery, and the development of electrical home appliances, such as an electrical vacuum cleaner, whose performance is reinforced, and new products, such as a motor-driven bicycle and the like. In accordance with the required high output of such a power supply unit, a high-voltage power supply unit has been needed.

Currently, the generally called high-voltage of a power supply unit used for such products means 30V or more, and its upper limit in the international rating is 42V from the viewpoint of safety. For this reason, safe power supply voltage which is needed to realize such driving output required in a variety of the above-mentioned electrical products is considered to be in a range of 30V to 42V. Direct current obtained by rectifying AC mains power supply voltage used in such devices is far higher and amounts to a range of 140V or 300V.

In the switch of such a current circuit, coping with high voltage/large current which can be used to open and close such a high voltage power supply unit has been needed.

However, in the case of direct current, it is known that when cutting off large current, the influence of an arc generated between the contacts of a switch to be opened increases as the voltage of the power supply unit increases. For example, it is known that if a power supply unit is closed by the conventional switch when the power supply voltage is DC 42V, and even when current is approximately 10 A, generally voltage at the time of closing contacts becomes higher than voltage at the time of opening the contacts. In this case., not only an arc is easy to occur, but also the occurrence time of an arc becomes longer.

If large current of, for example, 50 A is used even when voltage is in the neighborhood of 30V or if such a current circuit is cut off by the conventional switch when highly inductive load is driven using a coil, such as in a motor, a relay and the like, an arc is easy to occur and its occurrence time increases. This is because high surge voltage occurs if such high voltage/large current is cut off.

If a distance between contacts to be opened at the time of cutting off current is short or if an arc between contacts increases beyond a limit, such phenomenon often becomes remarkable, and an arc generated between the contacts often does not extinguish instantly and continues for several tens of milli-seconds. If an arc continues for several tens of milli-seconds like this, the arc generates high heat. As a result, the circuit is short-circuited by melting down the contacts and generating fusion between the contacts. Alternatively, even if the contacts are maintained open, a dielectric member around the contacts often melts, produces smoke or fire by heat, which is a problem.

If an opened distance between the contacts of a switch is widened, at least the problem of contact fusion can be solved. The occurrence time of an arc can also be shortened. However, even if the occurrence time is shortened, an arc occurs immediately after opening the contacts. Therefore, the problem of contact meltdown cannot be solved. Specifically, every time current is cut off, the contacts melt and deform, and accordingly, the life of switch is shortened.

Widening the opened distance between the contacts of a switch means the large-scaled structure of the main body of a switch. In the recent trend of the miniaturization of motor-driven parts in all electronic devices, a large-scaled switch must be avoided first of all.

However, as a method for dissolving or suppressing sparks between the contacts, inserting a resistor between the contacts is also known. However, the value of a resistor sufficient to reduce current so as to dissolve or suppress sparks is very low. If such a low resistance value is connected even after the contacts are opened, the accumulated amount of leak current becomes too large to neglect and uneconomical.

A variety of devices for absorbing surge voltage (or surge current) are also known. For example, for the surge voltage absorbing devices, a varister, a silicon surge absorber, a gas arrester using discharge and the like, are known. However, any of these devices is used to protect circuits driven by the above-mentioned voltage in use from abnormal surge voltage by absorbing high surge voltage at the time of emergency, different from voltage in use, and is not originally used to absorb surge voltage almost the same as voltage used at the time of the opening/closing of a switch.

Since the surge voltage absorbing devices are used for such a purpose, in the functional characteristic of the surge voltage absorbing device, the range of voltage in use is narrowed against surge limiting voltage, and a difference between this narrow-ranged voltage in use and surge restricting voltage is used as a safety margin.

Therefore, even if a surge voltage absorbing device which is used to absorb high voltage at the time of emergency, different from the voltage in use, and has a characteristic that a safety margin is set between voltage in use and surge restricting voltage, is inserted between the contacts of a normal switch, the surge voltage absorbing device does not operate, that is, cannot fulfill a function to absorb surge voltage, since surge voltage at the time of the opening/closing of the switch is almost the same as the voltage in use.

As one of devices for preventing excessive current, a positive temperature coefficient (PTC) is also known besides the above-mentioned devices. A PTC has a characteristic that even if initially large current flows, it is finally attenuated and suppressed to a weak level. Therefore, a PTC is used to prevent excessive current, but also is used as a heating element whose temperature rapidly rises. A PTC is also used as a non-contact switch for supplying equipment which requires large current only initially, such as the magnetic neutralizing coil of a color TV set, with current or for energizing a motor. In any case, a PTC has never been used as a surge voltage absorbing device at the time of cutting off current, nor has been considered like that.

Since generally a surge voltage absorbing device has the nature of absorbing surge voltage by reducing its resistance value by self-heating, using higher voltage, if far higher excessive voltage is applied, in the worst case, thermal runaway occurs and self-destruction is caused. For this reason, there is a possibility that a circuit to be protected may be short-circuited. Therefore, from this point of view too, the conventional surge voltage absorbing device has not been consideration to absorb surge voltage far higher than power supply voltage generated in the contacts of a switch.

An object of the present invention is to provide a small-size switch, whether it is a manually operated type, a relay type or a thermal protector type, for safely cutting off large direct current with high-voltage, without fusing or damaging contacts, in order to solve the conventional problems.

### DISCLOSURE OF INVENTION

In the preferred embodiment of the present invention, a direct current cutoff switch comprises a first fixed contact which is formed in a prescribed inner position and is connected to a terminal unit to be connected to an external circuit, a second fixed contact which is formed in another prescribed inner position and is connected to a terminal unit to be connected to an external circuit, a movable unit with conductivity, for supporting first and second movable contacts which are disposed in positions corresponding to the first and second fixed contacts, respectively, a contact pressing means for flowing direct current between the first and second fixed contacts via the first movable contact, the movable unit and the second movable contact by pressing the first and second movable contacts of the movable unit on the first and second fixed contacts, respectively, a contact opening means for first separating the first movable contact pressed on the first fixed contact from the first fixed contact and then separating the second movable contact pressed on the second fixed contact from the second fixed contact, and a non-linear resistor inserted and connected between the movable unit and the first fixed contact. The non-linear resistor has a resistance value fluctuation area for indicating the minimum resistance value while inter-contact voltage shifts from 0V to the power supply voltage when large direct current between both the contacts is cut off by separating the first movable contact from the first fixed contact by the contact opening means, and after the direct current between the first and second fixed contacts is completely cut off by separating the second movable contact from the second fixed contact, the non-linear resistor is electrically separated from a contact circuit.

In this direct current cutoff switch, for example, the above-mentioned non-linear resistor is a PTC, and contact opening voltage at the time of cutting off the above-mentioned large direct current by opening the above-mentioned movable contact is located in the range of 28V to 48V.

The PTC has, for example, a voltage/current characteristic that upper limit voltage is located in the range where no thermal runaway occurs or a lower peak value is 80V or more. For example, the position of peak current against voltage in the range where no thermal runaway occurs is located in the range of 2V to 20V.

It is preferable for the above-mentioned external circuit to be a circuit with the rating of DC 42V or a circuit for driving inductive load.

The above-mentioned movable member can be driven, for example, by a bi-metal. In this case, it is preferable for the external circuit to be a charging circuit or a charging/discharging circuit of a 28V or more secondary battery pack, and also to be a rated circuit whose opening voltage generated by the opening of the movable contact at the time of charge or at the time of charge/discharge does not exceed 50V. Furthermore, in this case, it is preferable in the PTC, for example, for Tc (Curie temperature) to be set in a value higher than the operating temperature of the bi-metal.

The movable member can also be driven by an electromagnetic coil.

The non-linear resistor is structured so as to prevent an arc generated between the first movable contact and the first fixed contact when the first movable contact is opened, from continuing for two milli-seconds or more. For example, the resistance value of the non-linear resistor is also designed so as to prevent current after opening the first movable contact from generating an arc or preferably so as to restrict the current to 1A or less.

The non-linear resistor can also be a PTC, and, for example, the contact opening voltage at the time of the cutoff of large direct current, generated by the opening of the movable contact can also be set in the range of 130V to 310V.

As described above, according to the present invention, since a PTC whose voltage/current characteristic and temperature characteristic are especially set is parallel connected to the contact circuit of a switch which is opened in the first place, of switches opened before and after, a closed circuit is formed and surge voltage is difficult to occur even if high-voltage current is cut off by opening the contacts of the first switch. Then, the PTC passes through the minimum resistance area to almost cut off current and further to complete the current cutoff operation by a contact opened later. Thus, direct current with 30V to 50V or higher voltage of 130V to 310V can be rapidly and certainly cut off without setting a distance between contacts to be opened wide. Accordingly, the miniaturization of a switching mechanism can be realized, the recent miniaturization of electronic equipment can be easily realized and its usage can be extended, which is convenient.

Since surge voltage is difficult to occur, no arc occurs between contacts. Therefore, the contacts can be prevented from fusing. Accordingly, a highly-reliable long-life high-voltage direct current cutoff switch can be provided.

### BRIEF DESCRIPTION OF DRAWINGS

FIG. 1A is a section view showing the structure of a push-button type manually-operated switch as a direct current cutoff switch in the first preferred embodiment. FIGS. 1B and 1C show the operating states of this manually-operated switch together with FIG. 1A.

FIGS. 2A, 2B and 2C typically show the circuit configurations of the manually-operated switch, corresponding to FIGS. 1A, 1B and 1C as well as the configuration of an external circuit.

FIG. 3 is a voltage/current characteristic chart obtained by manufacturing the switch using a variety of PTCs as samples and examining the relationship between their voltage and current by experiment.

FIG. 4 is a table in which the major characteristics of each PTC obtained from the voltage/current characteristic diagram are indicated by numeric values for the purpose of easy reading.

FIG. 5A shows changing current obtained when cutting off 42V current by the conventional thermostat in which PTCs are not provided for the purpose of comparison. FIG. 5B shows changing current obtained when cutting off 42V current by the thermostat of the present invention, in which PTCs are provided.

FIGS. 6A, 6B and 6C show the structures of an electro-magnetic relay as a direct current cutoff switch in the second preferred embodiments.

FIGS. 7A, 7B and 7C show the structures of a thermostat as a direct current cutoff switch in the third preferred embodiment.

FIG. 8 shows other examples where a contact circuit includes a PCT.

### CODES

1 Manually operated switch
2 Housing

2-1 Position determining projection section
3-1, 3-2 External connecting terminal
4-1 First fixed contact
4-2 Second fixed contact
5-1 First movable contact
5-2 Second movable contact
6 Movable unit

6-1 Catching hole

6a Connecting wire
7 Spring plate
8 Contact operating means

8-1 Rising/falling section
8-1-1 Catching projection section
8-2 Latchet section
8-3 Push button
9 PTC

9-1 Top electrode

9-2 Bottom electrode
10 External circuit
11-1 Connecting terminal
11-2 Connecting terminal
12 Table
12-1 Field of sample No.
12-2 Field of resistance value at 25° C.
12-3 Field of current at 25° C.
12-4 Field of peak current position
12-3 Field of lower peak position
13 Arc
15 Electro-magnetic relay
16 Housing
17 Support member
18 Electro-magneto

18-1 Coil

18-2 Core
19 Movable member
21 Spring plate

21-1 One tip

21-2 The other tip
22-1 First movable contact
22-2 Second movable contact
23-1, 23-2 Terminal unit
24 Connecting member
25-1 First fixed contact
25-2 Second fixed contact
26 Spring member
27 PTC
30 Thermostat
31-1,31-2 Terminal unit

31-1-1 Inner terminal
32 Housing
33-1 First fixed terminal
33-2 Second fixed terminal
34 Bi-metal
36-1,36-2 Bi-metal engaging nail
36 Movable plate
37-1 First movable terminal
37-2 Second movable terminal
38 Fixed unit
39 PTC
41-1 First movable terminal
41-2 Second movable terminal
42 PTC

### BEST MODE FOR CARRYING OUT THE INVENTION

The preferred embodiments of the present invention are described below with reference to the drawings. The direct current cutoff switch embeds a PTC with a special characteristic, which is described later.

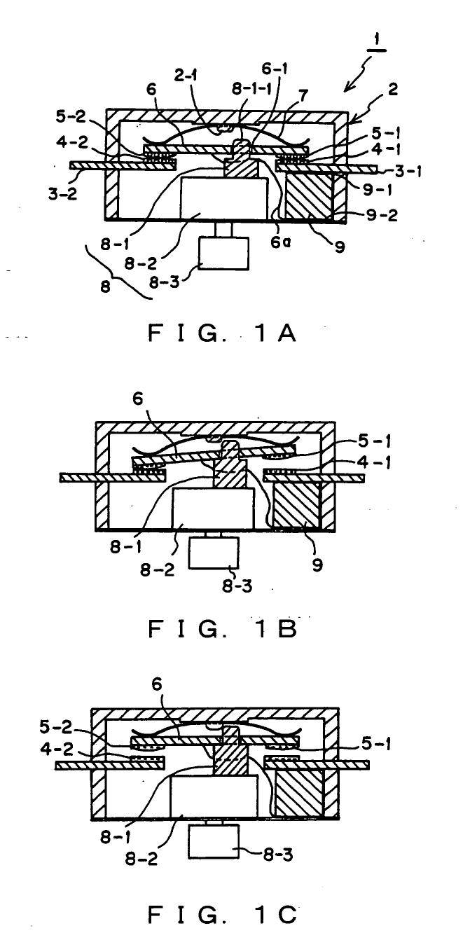

FIG. 1A is a section view showing the structure of a push-button type manually-operated switch as a direct current cutoff switch in the first preferred embodiment. FIGS. 1B and 1C show the operating states of this manually-operated switch together with FIG. 1A.

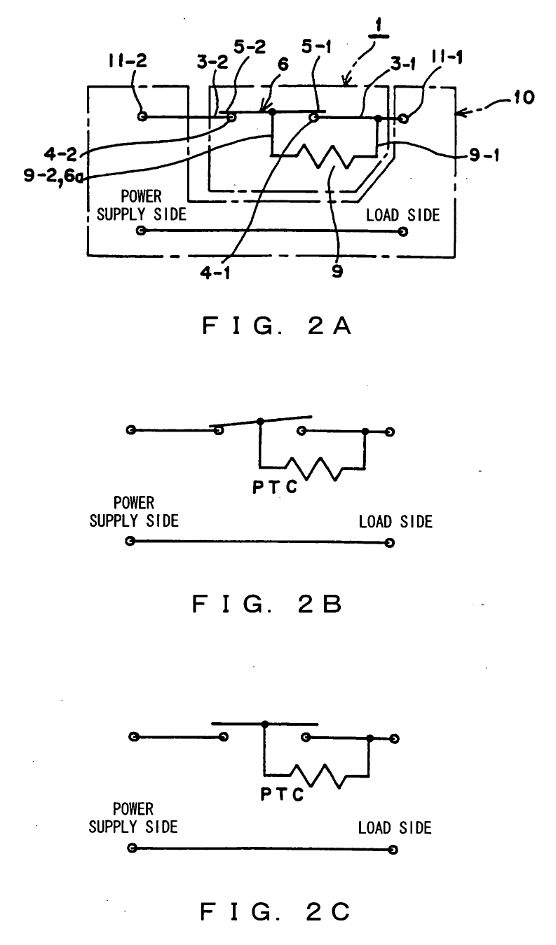

FIGS. 2A, 2B and 2C typically show the circuit configurations of the manually operated switch, corresponding to FIGS. 1A, 1B and 1C as well as the configuration of an external circuit.

The manually operated switch 1 shown in FIGS. 1A and 2A comprises a first fixed contact 4-1 which is disposed and formed in a prescribed position (in FIG. 1A, right against the center) of a housing 2 shown in FIG. 1A and is connected to a connecting section 3-1 to be connected to the connecting terminal 11-1 of an external circuit 10 shown in FIG. 2A, and a second fixed contact 4-2 which is disposed and formed in another prescribed position (in FIG. 1A, left against the center) of the housing 2 and is connected a connecting section 3-2 to be connected to the connecting terminal 11-2 of the external circuit 10 shown in FIG. 2A. The manually operated switch 1 further comprises a first movable contact 5-1 and a second movable contact 5-2 which are disposed in positions opposing to the first fixed contact 4-1 and the second fixed contact 4-2, respectively, and a movable unit 6 with conductivity, for supporting both the first movable contact 5-1 and the second movable contact 5-2.

Above this movable unit 6, as shown in FIG. 1A, an upward convex spring plate 7 is fit into a position determining projection section 2-1 projected and provided on the ceiling (Although it is called a ceiling since it is positioned in the upper section of FIG. 1A, in reality, it is the mounting surface of this switch, and in most cases it is actually disposed horizontally or downward. Hereinafter, similarly, positions are referred to as shown in figures.) through a hole opened and provided at its center, is positioned and provided. Each end of this spring plate 7 is pressed on each end of the movable unit 6, and the spring plate 7 presses each end of the movable unit 6, that is, the first movable contact 5-1 and the second movable contact 5-2 which are supported by each end bottom surface of the movable unit 6, downward as a contact pressing means. Thus, the spring plate 7 always presses the first movable contact 5-1 and the second movable contact 5-2 on the first fixed contact 4-1 and the second fixed contact 4-2, respectively, and flows direct current between the first fixed contact 4-1 and the second fixed contact 4-2 via the movable unit 6 with conductivity, that is, the first movable contact 5-1 and the second movable contact 5-2.

Under the movable unit 6, a contact operating unit 8 as a contact opening means, composed of a rising/falling section 8-1, a latchet section 8-2 and a push-button 8-3, is provided. The rising/falling section 8-1 of the contact operating unit 8 is disposed a little close to the first movable contact 5-1 against the center in the latchet section 8-2, and a catching projection section 8-1-1 projected and provided on the top of this rising/falling section 8-1 is inserted through a catching hole 6-1 formed on the movable unit 6 disposed a little close to the first movable contact 5-1 against its center. Thus, the movable unit 6 and the contact operating unit 8 are engaged.

A quadrangular prismatic PTC 9 is disposed and provided between the bottom surface of an external connection terminal 3-1 inserted from the outside to the inside of the housing 2 and the bottom surface of the housing 2, as a non-linear resistor. The shape of this PTC 9 is not limited to a quadrangular prism, and can be an arbitrary prism, such as a triangular prism, a multangular prism, including a quinquangular prism, etc., a cylinder or the like.

An electrode is formed on each of the top and bottom surfaces of the PTC 9, and the top electrode 9-1 and the bottom electrode 9-2 are connected to the bottom surface of an external connecting terminal 3-1 and a connecting wire 6a led from the movable unit 6, respectively. Thus, as shown in FIG. 2A, the PTC 9 is parallel connected to a contact circuit composed of the first movable contact 5-1 and the first fixed contact 4-1.

In the above-mentioned configuration, when the push-button 8-3 of the contact operating unit 8 is pushed inside the housing 2 (in FIG. 2A, pushed upward), this pushing is conveyed to the rising/falling section 8-1 via the latchet section 8-2, and the rising/falling section 8-1 rises. By this rising of the rising/falling section 8-1, the movable unit 6 is pushed upward and attempts to shift upward.

As described above, since the engaging point of the rising/falling section 8-1 and the movable unit 6 is positioned a little close to the first movable contact 5-1 against the center, if this engaging point is used as the fulcrum, pushing torque applied to each end of the movable unit 6 from the spring plate 7 is stronger at the second movable contact 5-2 whose distance from the fulcrum is longer, than at the first movable contact 5-1 whose distance from the fulcrum is shorter.

Therefore, as shown in FIG. 1B and FIG. 2B, as the movable unit 6 that is pushed upward by the rise of the rising/falling section 8-1 and attempts to shift upward, at first the first movable contact 5-1 side whose downward pushing torque is relatively weak shifts upward. In other words, at first the first movable contact 5-1 is separated from the first fixed contact 4-1, and current that flows through these contacts is cut off.

Here, the function of the PTC 9 which is parallel connected to a contact circuit composed of the first movable contact 5-1 and the first fixed contact 4-1, is described. As shown in FIGS. 1A and 2A, when a switch composed of the first movable contact 5-1 and the first fixed contact 4-1 is closed in the PTC 9 as this non-linear resistor, the voltage between the top electrode 9-1 and the bottom electrode 9-2 is almost “0”, and no current flows in the PTC 9 with a prescribed resistance value at 25° C.

In this case, even when the switch of the first movable contact 5-1 and the first fixed contact 4-1 is open as shown in FIGS. 1B and 2B, the entire circuit is closed since the PTC 9 is parallel inserted and connected between the first movable contact 5-1 and the first fixed contact 4-1, and accordingly, surge is difficult to occur.

However, after the contacts are opened, since power supply voltage is applied to the PTC 9, the PTC 9 instantly heats up and the heat reduces its resistance value up to a value at which prescribed peak current flows, based on the characteristic of the PTC 9. Therefore, surge voltage becomes difficult to occur.

Thus, no current flows between the first movable contact 5-1 and the first fixed contact 4-1 that are opened, due to surge voltage. In other words, no arc is generated between the first movable contact 5-1 and the first fixed-contact 4-1 that are opened.

Since current continues to flow in the PTC 9, the PTC 9 further heats up, and this time the resistance value increases. In this case, at power supply voltage, only very little and negligible current flows. In this preferred embodiment, then the rising/falling section 8-1 further is lifted by further pushing the push-button 8-3. As a result,- as shown in FIGS. 1C and 2C, the second movable contact 5-2 side of the movable unit 6 also shifts. Specifically, after the first movable contact 5-1 at first separates from the first fixed contact 4-1, the second movable contact 5-2 separates from the second fixed contact 4-2 in succession.

Thus, large direct current that flows between the first fixed contact 4-1 and the second fixed contact 4-2 via the first movable contact 5-1, the movable unit 6 and the second movable contact 5-2, is completely cut off. After this current cutoff is completed, the PTC 9 is electrically separated from these contact circuits and the state is maintained in the PTC 9.

As described above, this manually operated switch can completely cut off high-voltage direct current. Furthermore, while the manually operated switch cuts off direct current with such high voltage of 30V to 42V (in some case 50V) rapidly and completely, no arc occurs between contacts, and accordingly, no contacts melt down.

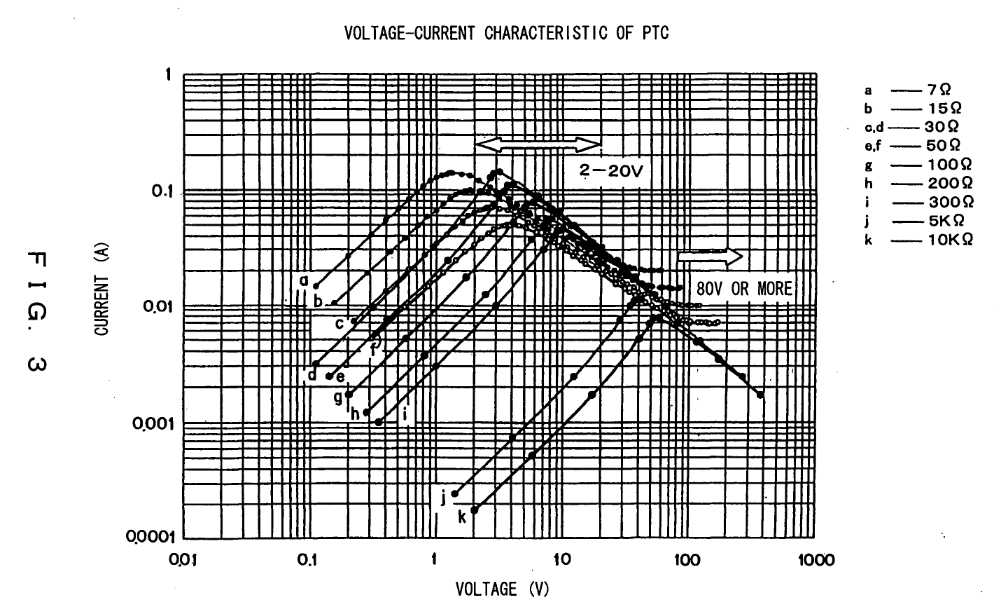

FIG. 3 is a voltage/current characteristic chart obtained by manufacturing a switch for trial, using a variety of PTCs each with a different characteristic as samples in order to obtain a PTC 9 with the above-mentioned voltage characteristic, examining the relationship between their voltage and current by experiment and plotting the examination results. The horizontal and vertical axes indicate voltage (V) and current (A), respectively. The respective scales of the horizontal and vertical axes are expressed in logarithm.

Resistance values at the left end of each characteristic curve of the voltage/current characteristic chart shown in FIG. 3 indicate resistance values at 25° C. The resistance value at the ambient temperature condition of 25° C. is used as a reference for specifying and identifying a PTC, which is a non-linear resistor.

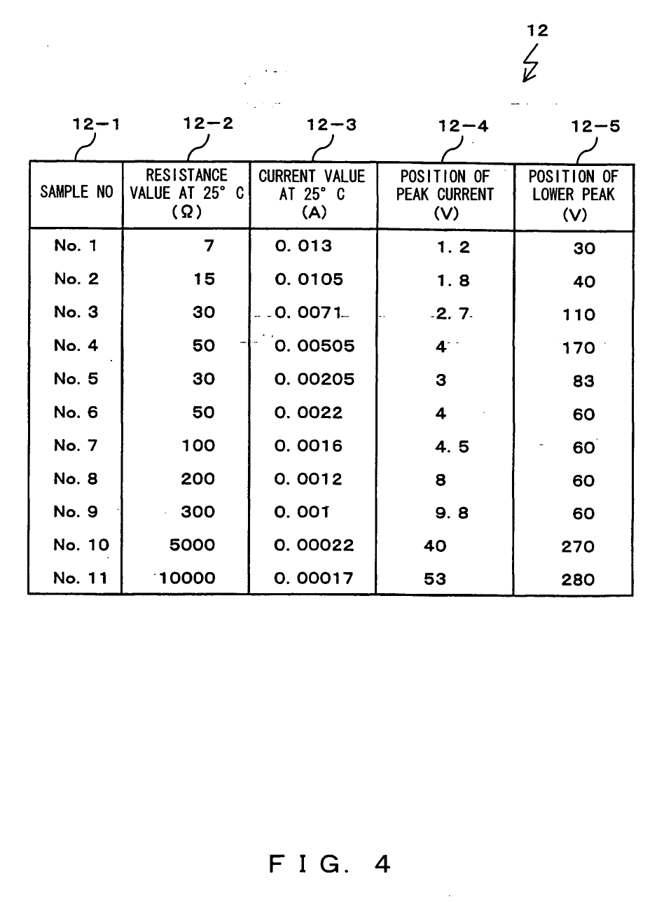

FIG. 4 is a table in which the major characteristics of each PTC obtained from the voltage/current characteristic chart are indicated by numeric values for the purpose of easy reading. As shown by the field of sample No. 12-1 and the field 12-2 of resistance value at 25° C. of Table 12 in FIG. 4, sample Nos. No. 1 through No. 11 are attached to PTCs with the resistance values at the left end of each characteristic curve of the voltage/current characteristic chart shown in FIG. 3, of 7 Ω, 15 Ω, 30 Ω, 50 Ω, 30 Ω, 50 Ω, 100 Ω, 200 Ω, 300 Ω, 5K(5000)Ω and 10K(10,000)Ω, respectively.

Here, the characteristics of a PTC, including thermal runaway, are described. As to the characteristics of a PTC, if power supply voltage is 100V or 200V, an initial resistance of approximately 5 KΩ to 10 KΩ is used. In this case, the PTC has a characteristic that a peak current position against voltage in the range where no thermal runaway occurs, in the voltage/current characteristic is 50V or more. If such a PTC is used for direct current with high voltage (30-42V), resistance decrease does not accompany an arc generated at the time of cutoff and almost the same state as a fixed resistance is connected, occurs. In this case, since voltage at each end of a thermostat, which is divided with load resistance, does not decrease much, an arc cannot be reduced.

However, in the PTC, a peak current position against voltage in the range where no thermal runaway occurs, in the voltage/current characteristic is set to a value lower than the above-mention direct current voltage, that is, 50V, power supply voltage higher than voltage which generates the minimum resistance value is applied to the PTC at the time of current cutoff by opening the terminals of a switch. In this case, the PTC is parallel inserted and connected between the contacts, and voltage between the terminals of the switch drops up to voltage obtained by subtracting drop due to load from 0V, in a short time.

Specifically, even if a section between the terminals of the switch is clamped by the PTC and the circuit is cut off, the circuit remains a closed circuit without an open part, and transitional surge voltage becomes difficult to occur. Besides, the PTC has a section with the minimum resistance value, and current which flows through the PTC also has a peak.

Even in the case of fairly high resistance of 300 Ω, the peak of the voltage/current characteristic is located around 10V. In this case, although current at 42V is 0.015 A in this static characteristic, the current goes through a peak of 0.045 A during the period. Although the resistance is calculated to be the minimum resistance of approximately 222 Ω, based on the graph shown in FIG. 3, in the course of cutoff, this resistance is connected to an arc, and the resistance value has the minimum value. Therefore, surge voltage is difficult to occur, and the continuation of the arc is also suppressed. Thus, the arc is extinguished in the course of cutoff.

However, if two 12V system batteries are connected in series, the maximum voltage is 28V. If three 12V system batteries are connected in series, the maximum voltage is 42V. When this 28V is set as the lower limit, it is effective if the above peak current is set in voltage lower than.28V, specifically, in the range up to 20V. This capability can increase if a resistance value is reduced. However, if excessive voltage is applied to a PTC, specifically, if voltage out of self-control is applied, current rapidly increases and enters a thermal runaway area.

Specifically, there is a point where if excessive voltage is applied to an area (lower right) in which resistance increases as voltage increases, in the voltage/current characteristic chart shown in FIG. 3, a curve turns to rise (a curve changing part on the high voltage side; although in FIG. 3, the part seems almost horizontal, in reality the right end of the part rises a little). This point is called a lower peak or a pressure marginal point. Since a PTC enters the above-mentioned thermal runaway area when going beyond this point, and incurs self-destruction, the point is also called a thermal runaway generating point.

Therefore, a PTC has an upper limit condition against voltage, and this upper limit condition becomes the above-mentioned lower peak (thermal runaway generating point) of the curve. At least, it is necessary to ensure safety by setting the voltage of the lower peak of this curve to twice as high as normal voltage in use, and 80V is its guide. If this condition is specified by the peak current value of the voltage/current characteristic, in a characteristic on the voltage side lower than 2V, a pressure characteristic on the high voltage side is not sufficient. Therefore, the condition can be limited to the range of almost 2V to 20V.

As shown in the field of a lower peak position 12-5 in Table 12, as to samples No. 1 and No. 2 shown in FIG. 4, the lower peak position is lower than 2V, and its withstand voltage characteristic on the high voltage side is not sufficient and safety cannot be secured at voltage in use, as described above. Therefore, samples No. 1 and No. 2 are excluded from targets to be adopted.

The position (V) of peak current shown in the field of peak current position 12-4 indicates the position of voltage, at which the initial current which flows in a PTC becomes the maximum. It is better for current which flows in the PTC immediately after the switch is opened, to be the maximum, as shown in FIGS. 1A and 2B. In order to maximize current which flows in a PTC immediately after the switch is opened, the position (value) (V) of peak current should be as small as possible, since voltage applied to the PTC 9 immediately before the switch is opened is almost “0”, as shown in FIGS. 1A and 2A.

Then, since samples No. 1 and No. 2 are already excluded, the remaining samples No. 3 through No. 11 are checked. As a result, since it is found that the respective position (values) (V) of peak current of samples No. 3 through No. 9 are one digit and the respective positions (V) of peak current of samples No. 10 and No. 11 are higher than voltage in use (in this example, 48V or less), samples No. 10 and No. 11 are excluded from targets to be adopted. Therefore, only samples No. 3 through No. 9 remain as targets to be adopted.

Thus, it is determined that PTCs which do not cause thermal runaway at target voltage (48V or less) and can be safely used are samples No. 3 through No. 9. Each of such PTCs has a voltage/current characteristic that the position of peak current is located in the range of 2V to 20V.

In the field of a lower peak position 12-5 of Table 12 shown in FIG. 4, any of the respective positions of a lower peak of samples No. 3 through No. 9 is located between 60V and 170V, that is, 42V or more. More particularly, since each of the respective positions of a lower peak of PTC samples No. 3 through No. 5 is 80V or more, which is almost twice the rated voltage 42V of the above-mentioned power supply unit, each of them has a preferable characteristic. It is found that each of them is suitable as a PTC 9 to be parallel inserted and connected between the first movable contact and the first fixed contact of the manually operated switch 1 connected to the external circuit 10, as shown in FIGS. 2A, 2B and 2C.

In FIG. 4, since more particularly, each of the respective positions of a lower peak of samples No. 3 and No. 4 is located between 110 V and 170V, it is found they are suitable even if the rated voltage of the power supply unit is 50V.

A PTC has the start point of a temperature area in which a resistance value suddenly increases, and this temperature is called “Curie temperature (Tc)”. This temperature is defined as temperature corresponding to a resistance value twice as much as the minimum resistance value. The minimum resistance value is the position (V) of peak current shown in FIG. 4.

Therefore, it is necessary to select and adopt one whose Curie temperature is set to a value higher than operating temperature, from the samples No. 3 through No. 9 so as to pass through the minimum resistance area before it operates and its contacts are opened.

A desired PTC can be obtained by changing not only its above-mentioned voltage/current characteristic but also its temperature characteristic.

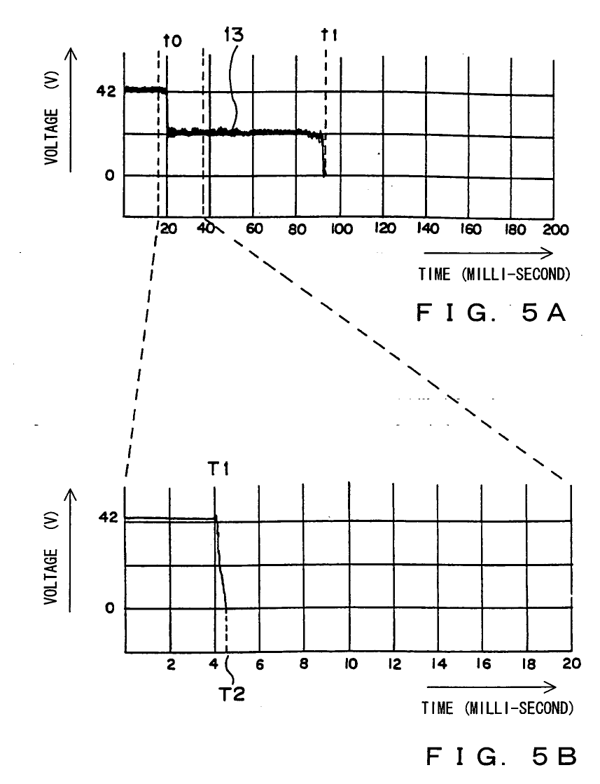

FIG. 5A shows changing current obtained when cutting off 42V current by the conventional switch configuration in which PTCs are not disposed nor provided for the purpose of comparison. FIG. 5B shows changing current obtained when cutting off 42V current by the switch configuration of the present invention, in which PTCs are disposed and provided.

In FIGS. 5A and 5B, the horizontal and vertical axes indicate time and voltage, respectively. The unit time scales on the horizontal axis of FIG. 5A and 5B are 20 milli-seconds and two milli-seconds, respectively.

In FIG. 5A, 70 milli-seconds and a little elapse between time t0 when the contacts of a switch (switch composed of the first movable contact 5-1 and the first fixed contact 4-1, hereinafter the same) are opened and 42V current is cut off and time t1 when current is completely cut off between the contacts and voltage becomes 0 (in this case, it means hereinafter that current is 0). Specifically, during this period, an arc 13 occurs between the contacts, and the generation of the arc 13 continues for 70 milli-seconds or slightly more. If an arc continues to occur for 70 milli-seconds or more, contacts easily melt down, are short-circuited by fusion or the like, and accordingly, the switch is destroyed.

However, in the example shown in FIG. 5B, only one milli-second elapses between time T1 when the contacts of a switch are opened and 42V current is cut off and time T2 when current is completely cut off between the contacts and voltage becomes 0. In other words, the switch of the present invention can certainly cut off high-voltage direct current 70 or more times as fast as the conventional switch. Furthermore, since no arc occurs, no contacts melt, and accordingly, the life of the switch is remarkably extended.

Although in the above-mentioned preferred embodiments, the description is made using a manually operated switch as an example, the switch is not limited to a manually operated switch, and for example, an electromagnetic relay can also be used. Another preferred embodiment using an electromagnetic relay as the switch is described below.

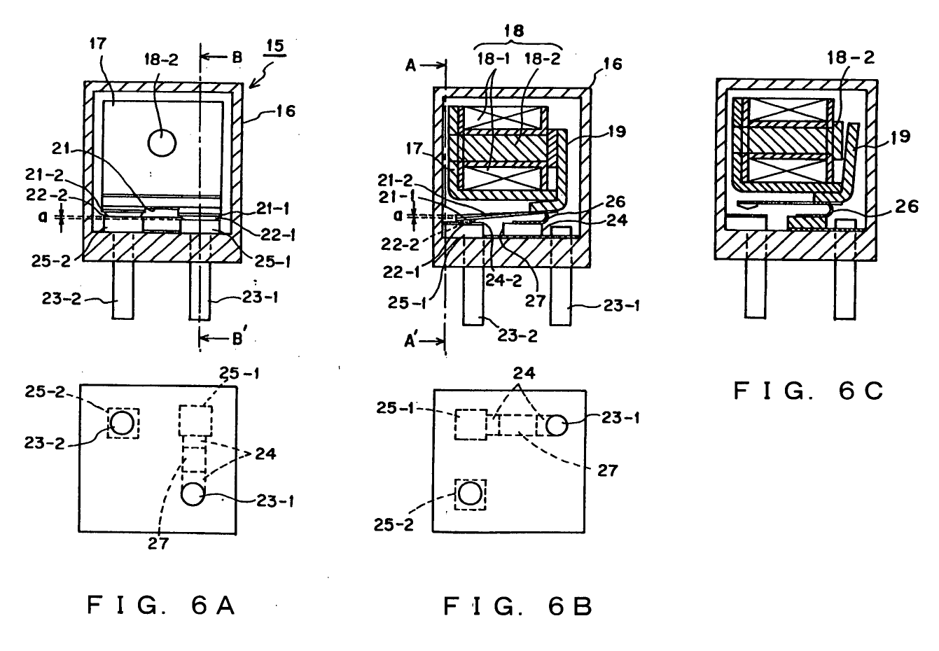

FIGS. 6A, 6B and 6C show the structures of an electro-magnetic relay as a direct current cutoff switch in the second preferred embodiments. FIG. 6A shows the A-A′ section view of FIG. 6B in the upper section and its bottom view in the lower section. FIG. 6B shows the B-B′ section view of FIG. 6A in the upper section and its bottom view in the lower section. FIG. 6C is the section view of the opened switch.

As shown in FIGS. 6A and 6B, an electro-magnetic relay 15 is supported by a supporting member 17 which occupies much of the interior of a housing 16, and an electro-magneto composed of a coil 18-1 and a core 18-2 is disposed and provided in the electromagnetic relay 15.

In the neighborhood of the attraction end of the core 18-2, one long arm end of a movable member 19 whose section is shaped in a hook is opposed and disposed. FIG. 6B shows a state where one long arm end of the hooked movable member 19 is attracted to the attraction end of the core 18-2.

On the other short arm end of the hooked movable member 19, a spring plate 21 is fixed and provided. On the bottom surface of one of the forked tip 21-1 of this spring plate, a first movable contact 22-1 is fixed and provided, and on the bottom surface of the other tip 21-2, a second movable contact 22-2 is fixed and provided.

Under the first movable contact 22-1, a first fixed contact 25-1 is disposed and provided in a position opposing to this first movable contact 22-1. This first fixed contact 25-1 is connected to a terminal unit 23-1 which goes through the base of the housing 16 and projects outside via a connecting member 24 to be connected to an external circuit.

Under the second movable contact 22-2, a second fixed contact 25-2 is disposed and provided in a position opposing to this second movable contact 22-2. This second fixed contact 25-2 is directly connected to the internal terminal of a terminal unit 23-2 which goes through the base of the housing 16 and projects outside to be connected to an external circuit.

On the other short arm end of the movable member 19 on which the spring plate 21 is fixed, a spring member 26 whose section is shaped in a U character is mounted. The top surface of the horizontally U-shaped spring member 26 is fixed on the bottom surface of the other short arm end of the movable member 19, with the open end of the U character directed toward a contact, and a PTC 27 as a non-linear resistor is inserted and mounted between the bottom surface of the horizontally U-shaped spring member 26 and the connecting member 24 of the first fixed contact 25-1. The top electrode surface of the PTC 27 is connected to the bottom surface of the horizontally U-shaped spring member 26, and the bottom electrode surface of the PTC 27 is connected to a connecting plate 29.

When the electro-magneto 18 is energized and driven, as shown in FIGS. 6A and 6B, this electromagnetic relay rotates counter-clockwise against the pushing force of the spring member 26, using the boundary of the long and short arms as the fulcrum, by attracting the long arm end of the movable member 19 to the attraction end of the core 18-2. Then, the first movable contact 22-1 is pressed on the first fixed contact 25-1 by the pushing force of one tip 21-1 of the spring plate 21, and the second movable contact 22-2 is pressed on the second fixed contact 25-2 by the pushing force of the other tip 21-2 of the spring plate 21.

In this state, the same circuit as shown in FIG. 2A is formed by connecting the above-mentioned connecting terminals 23-1 and 23-2 to the connecting terminals 11-1 and 11-2, respectively, of the external circuit 10 shown in FIG. 2A.

As shown in FIG. 6A, the contact position of the first movable contact 22-1 and the first fixed contact 25-1 is set lower by height a than the contact position of the second movable contact 22-2 and the second fixed contact 25-2. Although the tips 21-1 and 21-2 of the spring plate 21 that make contact surfaces generate pushing force have the same pushing force, as shown in FIG. 6B, the tip 21-1 holding the first movable contact 22-1 sinks lower than the tip 21-2 by height a.

Therefore, if current to the electro-magneto 18 is cut off, as shown in FIG. 6C, the movable member 19 firstly separates the first movable contact 22-1 from the first fixed contact 25-1 that sinks by height a and the contacts are opened since the spring member 26 pushes them counter-clockwise, using the boundary of the long and short arms as the fulcrum. In this case, the circuit state becomes the same as that shown in FIG. 2B.

Since the PTC 27 is parallel connected to a contact circuit composed of the first movable contact 22-1 and the first fixed contact 25-1, in this case too, the contact circuit forms a closed circuit, and surge voltage is difficult to occur. In other words, in this case too, as shown in FIG. 5B, no arc occurs, and current is cut off within at least two milli-seconds.

Furthermore, the second movable contact 21-2 is also separated from the second fixed contact 25-2. Thus, current cutoff is completed, and after that, the PTC 27 continues to be electrically separated against these contact circuits.

As described above, this electro-magnetic relay 15 completely cuts off high-voltage direct current. Furthermore, since no arc occurs between contacts, and accordingly, no contacts fuse while direct current with high voltage of 30V to 42V (in some cases 50V) is rapidly and completely cut off, a small electromagnetic relay in which contacts can be disposed fairly close can be realized.

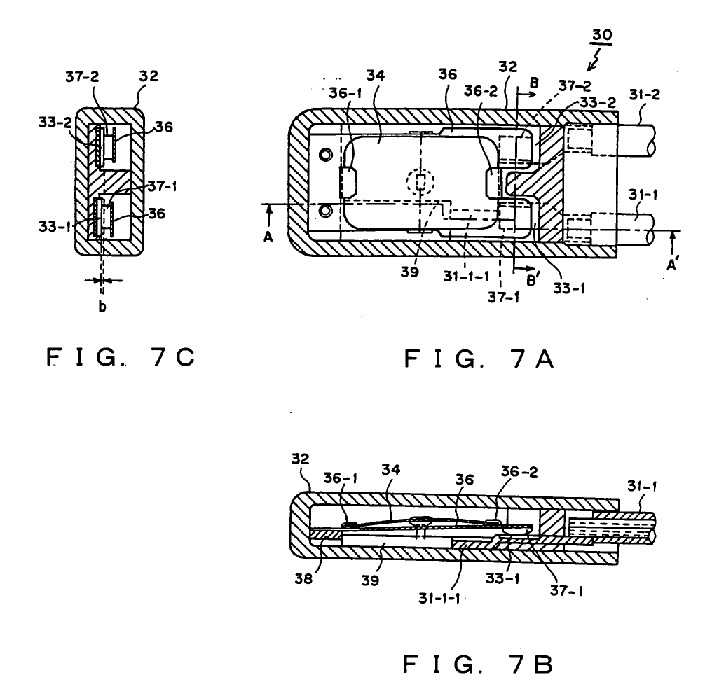

FIGS. 7A, 7B and 7C show the structures of a thermostat as a direct current cutoff switch in the third preferred embodiment. FIGS. 7A, 7B and 7C are the plat perspective view of a housing top, the A-A′ section view of FIG. 7A and the B-B′ section view of FIG. 7A, respectively.

As shown in FIGS. 7A, 7B and 7C, a thermostat 30 is provided with two terminal units 31-1 and 31-2 which projects through a housing 32 from inside to outside to be connected to an external circuit. On the top surface of the bottom end of the housing 32, the first fixed terminal 33-1 and the second fixed terminal 33-2 are formed on the terminal units 31-1 and 31-2, respectively.

In the housing 32, both a bi-metal 34 and a movable plate 36, one end of which vertically vibrates in accordance with the bending of this bi-metal 34, using a bi-metal engaging nail as the fulcrum, are disposed and provided. This vertically vibrating end of the movable 36 is forked, and in positions opposing to the first fixed terminal 33-1 and the second fixed terminal 33-2 on the bottom surface of the forked end, the first movable terminal 37-1 and the second movable terminal 37-2, respectively, are formed.

The bi-metal 34 is composed of two overlapped metal pieces which always bend, and the bending is inverted at a prescribed temperature. Within the range of normal temperature in use of this thermostat 30, the bi-metal 34 bends convex upward. One end of the bi-metal 34 is engaged in one bi-metal engaging nail 36-1 of the movable plate 36, and the other end is also engaged in the other bi-metal engaging nail 36-2 of the movable plate 36.

The end on the bi-metal engaging nail 36-1 of the movable plate 36 is fixed on a conductive fixed unit 38, and a PTC 39 is inserted and mounted between this fixed unit 38 and the internal terminal 31-1-1 of the terminal unit 31-1 with the first fixed terminal 33-1.

Thus, the terminal units 31-1 and 31-2 of this thermostat 30 are connected to the connecting terminals 11-1 and 11-2, respectively, of the external circuit shown in FIG. 2A, and the same entire circuit as shown in FIG. 2A is formed.

Since in this state, within the range of normal temperature in use of the thermostat 30, the bi-metal 34 bends convex, as described above, as shown in FIGS. 7B and 7C, the end on the bi-metal engaging nail 36-2 side of the movable plate 36 is pushed downward by the bi-metal 34, and by this, the first fixed contact 33-1 and the second fixed contact 33-2 are pressed on the first movable contact 37-1 and the second movable contact 37-2, respectively, at the relevant end of the movable plate 36. In other words, the thermostat 30 as a switch is closed.

In this case, when some failure occurs in the surrounding area and temperature exceeding the normal temperature in use of the thermostat 30 is conveyed to the bi-meta 34, the bending of the bi-metal inverts and its shape become upward convex. Thus, the end of the movable plate 36 on the side of the bi-metal engaging mail 36-2 is lifted upward.

In this case, as shown in FIG. 7B, the contact position of the first movable-contact 37-1 and the first fixed contact 33-1 is set lower by height b than the contact position of the second movable contact 37-2 and the second fixed contact 33-2, and the first movable contact 37-1 sinks lower by height b than the second movable contact 37-2. Therefore, the first movable contact 37-1 is separated from the first fixed contact 33-1 earlier when the end on the bi-metal engaging nail 36-2 side of the movable plate 36 is lifted upward. Thus, the circuit state becomes the same as shown in FIG. 2B.

Since the PTC 39 is parallel connected to a contact circuit composed of the first movable contact 37-1 and the first fixed contact 33-1, in this case too, the contact circuit forms a closed circuit, and surge voltage is difficult to occur between the first movable contact 37-1 and the first fixed contact 33-1. Specifically, in this case too, no arc occurs, as shown in FIG. 5B. Thus, within at least two milli-seconds, current is cut off.

Furthermore, then, the second movable contact 37-2 is also separated from the second fixed contact 33-2. Thus, current cutoff is completed, and after that, the PTC 39 continues to be electrically separated from these contact circuits.

As described above, this thermostat 30 completely cuts off high-voltage direct current. Furthermore, since no arc occurs between contacts, and accordingly, no contacts fuse while direct current with high voltage is rapidly and completely cut off, a small electro-magnetic relay in which contacts can be disposed fairly close can be realized.

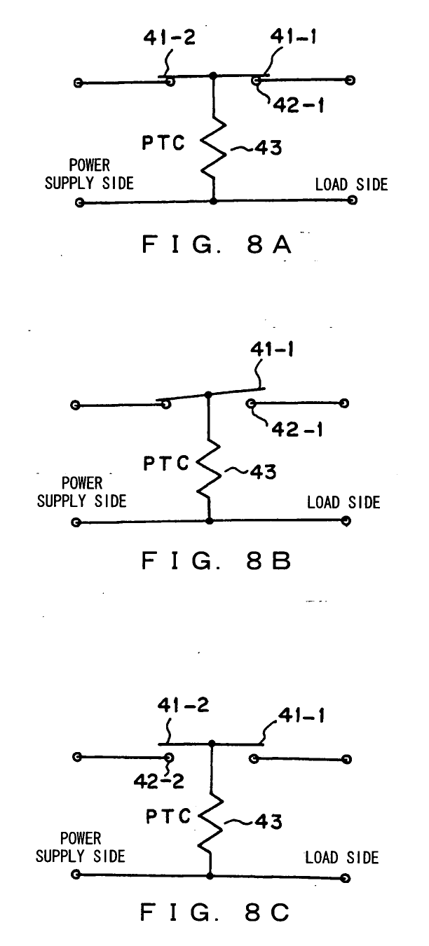

FIGS. 8A, 8B and 8C show other examples where a contact circuit includes a PCT. In this connection, effect obtained by reducing an arc is small. Specifically, if, as shown in FIG. 8B, the first movable contact 41-1 is separated from the first fixed contact 42-1, the power supply side circuit is made a closed circuit by a PTC 43. Therefore, in this case too, surge voltage is difficult to occur. However, the PTC 43 is already energized and its resistance value increases. Therefore, the effect is smaller than in FIG. 2. As shown in FIG. 8A, when the switch is closed, leak current flows in the PTC 43 although it is negligible. Even in this case, the present invention can be satisfactorily applied as long as target equipment to be connected is sufficiently considered as well as power supply voltage.

It is described above that in a PTC whose initial resistance is 5 kΩ to 10 kΩ, as shown as samples No. 10 and 11, a current peak position against voltage in the range where no thermal runaway occurs in the voltage/current characteristic, is 50V or more. In this case, if a PTC is used at high voltage of 30V to 42V, the state becomes the same as a case where a fixed resistor is connected since no resistance reduction accompanies an arc generated at the time of cutoff. Therefore, the voltage of the switch does not drop much, and accordingly, an arc cannot be reduced. However, this is true only with a case where high voltage of 30V to 42V is used.

In a PTC whose initial resistance is 5 kΩ to 10 kΩ, as shown as samples No. 10 and 11, the position of peak current is located in the range of 40V to 60V, and a lower peak is located in the range of 250V to 350V. Therefore, against direct current with high-voltage of 140V to 300V obtained by rectifying AC mains power supply voltage used inside equipment, a PTC can be parallel connected to the switch as in a PTC as samples No. 3 through No. 9 (preferably up to No. 5) against high voltage of 30 V to 42V, and the same effect as described above can be obtained.

### INDUSTRIAL AVAILABILITY

As described above, the direct current cutoff switch prevents the occurrence of the contact opening arc of a high-voltage direct current circuit or reduces the occurrence time, prevents the fusion and damage of contacts and completely cuts off high-voltage direct current. Accordingly, the present invention can be adopted in all industries using a direct current cutoff switch for cutting off direct current.

1. A direct current cutoff switch, comprising:
a first fixed contact which is formed in a prescribed inner position and is connected to a terminal unit to be connected to an external circuit;
a second fixed contract which is formed in another prescribed inner position and is connected to a terminal unit to be connected to an external circuit;
a movable unit with conductivity, for supporting first and second movable contacts which are disposed in positions corresponding to the first and second fixed contacts, respectively;
a contact pressing means for flowing direct current between the first and second fixed contacts via the first movable contact, the movable unit and the second movable contact by pressing the first and second movable contacts of the movable unit on the first and second fixed contacts, respectively;
a contact opening means for first separating the first movable contact pressed on the first fixed contact from the first fixed contract and then separating the second movable contact pressed on the second fixed contact from the second fixed contact; and
a non-linear resistor inserted and connected between the movable unit and the first fixed contact,
said non-linear resistor has a resistance value fluctuation area indicating the minimum resistance value while inter-contact voltage shifts from 0V to the power supply voltage when large direct current between both the contacts is cut off by separating the first movable contact from the first fixed contact by a contact opening means, and after the direct current between the first and second fixed contacts is completely cut off by separating the second movable contact from the second fixed contact, the non-linear resistor is electrically separated from a contact circuit.

2. The direct current cutoff switch according to claim 1, wherein
said non-linear resistor is a positive temperature coefficient (PTC), and the contact opening voltage at the time of the cutoff of the large direct current by the opening of the first movable contact is located in the range of 28V to 48V.

3. The direct current cutoff switch according to claim 1, wherein
said PTC has an upper limit voltage in which range no thermal runaway occurs or a voltage/current characteristic where a lower peak is in the range of 80V or more.

4. The direct current cutoff switch according to claim 3, wherein
said PTC has a voltage/current characteristic that the position of peak current against voltage in a range where no thermal runaway occurs is located in a range of 2V to 20V.

5. The direct current cutoff switch according to claim 3, wherein
said external circuit is a circuit with rating of direct current 42V or a circuit for driving induction load.

6. The direct current cutoff switch according to claim 4, wherein
said member movable is driven by a bi-metal, and
said external circuit is a charging circuit or a charging/discharging circuit of a 28V or more secondary battery pack and also is a rated circuit whose opening voltage generated by the opening of the movable contact at the time of charge or charge/discharge does not exceed 50V.

7. The direct current cutoff switch according to claim 6, wherein
in said PTC, Curie temperature (Tc) is set to a value higher than the operating temperature of the bi-metal.

8. The direct current cutoff switch according to claim 1, wherein
said movable member is driven by an electromagnetic coil.

9. The direct current cutoff switch according to claim 1, wherein
said non-linear resistor prevents an arc generated between the first movable contact and the first fixed contact at the time of the opening of the first movable contact from continuing for two milli-seconds or more.

10. The direct current cutoff switch according to claim 1, wherein
said non-linear resistor indicates a resistance value for restricting current after the first movable contact is opened to current by which an arc is not generated or preferably to 1 A or less.

11. The direct current cutoff switch according to claim 1, wherein
said non-linear resistor is a PTC, and contact opening voltage which flows at the time of the cutoff of the large direct current by the opening of the movable contact is located in a range of 130V to 3 10V.

12. The direct current cutoff switch according to claim 2, wherein
said PTC has an upper limit voltage in which range no thermal runaway occurs or a voltage/current characteristic where a lower peak is in the range of 80V or more.

13. The direct current cutoff switch according to claim 12, wherein
said PTC has a voltage/current characteristic that the position of peak current against voltage in a range where no thermal runaway occurs is located in a range of 2V to 20V.

14. The direct current cutoff switch according to claim 12, wherein
said external circuit is a circuit with rating of direct current 24V or a circuit for driving induction load.

15. The direct current cutoff switch according to claim 4, wherein
said external circuit is a circuit with rating of direct current 24V or a circuit for driving induction load.

16. The direct current cutoff switch according to claim 15, wherein
said external circuit is a circuit with rating of direct current 24V or a circuit for driving induction load.

17. The direct current cutoff switch according to claim 13, wherein
said member movable is driven by a bi-metal, and
said external circuit is a charging circuit or a charging/discharging circuit of a 28V or more secondary battery pack and also is a rated circuit whose opening voltage generated by the opening of the movable contact at the time of charge or charge/discharge does not exceed 50V.

18. The direct current cutoff switch according to claim 17, wherein
in said PTC, Curie temperature (Tc) is set to a value higher than the operating temperature of the bi-metal.

19. The direct current cutoff switch according to claim 2, wherein
said non-linear resistor prevents an arc generated between the first movable contact and the first fixed contact at the time of the opening of the first movable contact from continuing for two milli-seconds or more.

20. The direct current cutoff switch according to claim 3, wherein
said non-linear resistor prevents an arc generated between the first movable contact and the first fixed contact at the time of the opening of the first movable contact from continuing for two milli-seconds or more.

21. The direct current cutoff switch according to claim 2, wherein
said non-linear resistor indicates a resistance value for restricting current after the first movable contact is opened to current by which an arc is not generated or preferably to 1 A or less.

22. The direct current cutoff switch according to claim 3, wherein
said non-linear resistor indicates a resistance value for restricting current after the first movable contact is opened to current by which an arc is not generated or preferably to 1 A or less.
